(19) United States
(12) Patent Application Publication
(10) Pub. No.: US 2023/0419162 A1
(43) Pub. Date: Dec. 28, 2023

(54) COMPOSING A MACHINE LEARNING MODEL FOR COMPLEX DATA SOURCES

(71) Applicant: International Business Machines Corporation, Armonk, NY (US)

(72) Inventors: Ana Paula Appel, São Paulo (BR); Renato Luiz de Freitas Cunha, São Paulo (BR); PAULO RODRIGO CAVALIN, Rio De Janeiro (BR); Bruno Silva, São Paulo (BR)

(21) Appl. No.: 17/808,143

(22) Filed: Jun. 22, 2022

(51) Int. Cl. G06N 20/00

(52) U.S. Cl. CPC G06N 20/00

(57) ABSTRACT

In an approach to composing a machine learning model for complex data sources, a computer receives data and associated metadata corresponding to a machine learning task from a user. A computer determines a task context and a problem domain. A computer identifies the machine learning task. A computer evaluates a match between the problem domain and one or more pre-compiled models. A computer selects at least two of the one or more pre-compiled models. A computer generates one or more multimodal model combinations with the selected at least two of the one or more pre-compiled models. A computer executes the multimodal model combinations with the data and associated metadata. A computer displays the results of the executed one or more multimodal model combinations to the user. A computer determines whether a level of error associated with the results is acceptable to the user based on a response from the user.

### BACKGROUND OF THE INVENTION

The present invention relates generally to the field of machine learning, and more particularly to composing a machine learning model for complex data sources.

Currently, many industries are trending toward cognitive models enabled by big data platforms and machine learning models. Cognitive models, also referred to as cognitive entities, are designed to remember the past, interact with humans, continuously learn, and continuously refine responses for the future with increasingly accurate levels of prediction. Machine learning explores the study and construction of algorithms that can learn from and make predictions based on data. Such algorithms operate by building a model from example inputs in order to make data-driven predictions or decisions expressed as outputs, rather than following strictly static program instructions. Within the field of data analytics, machine learning is a method used to devise complex models and algorithms that lend themselves to prediction. These analytical models allow researchers, data scientists, engineers, and analysts to produce reliable, repeatable decisions and results and to uncover hidden insights through learning from historical relationships and trends in the data.

Automated Artificial Intelligence (AutoAI) is a variation of machine learning that extends automation of model building toward automation of the full life cycle of a machine learning model. AutoAI applies intelligent automation to the task of building predictive machine learning models by preparing data for training, identifying the best type of model for the given data, and then choosing the features, or columns of data, that best support the problem the model is solving. In addition, AutoAI may test a variety of tuning options to reach the best result as it generates, then ranks, model-candidate pipelines.

Natural language processing (NLP) is a field of computer science, artificial intelligence, and linguistics concerned with the interactions between computers and human (natural) languages. As such, natural language processing is related to the area of human-computer interaction. Many challenges in natural language processing involve natural language understanding, that is, enabling computers to derive meaning from human or natural language input.

### SUMMARY

Embodiments of the present invention disclose a computer-implemented method, a computer program product, and a system for composing a machine learning model for complex data sources. The computer-implemented method may include a computer receiving data and associated metadata corresponding to a machine learning task from a user. A computer determines a task context and a problem domain based on the received data and associated metadata. Based on the task context and the problem domain, a computer identifies the machine learning task. A computer evaluates a match between the problem domain and one or more pre-compiled models. Based on the match, a computer selects at least two of the one or more pre-compiled models. A computer generates one or more multimodal model combinations with the selected at least two of the one or more pre-compiled models. A computer executes the one or more multimodal model combinations with the received data and associated metadata. A computer displays the results of the executed one or more multimodal model combinations to the user. A computer determines whether a level of error associated with the results is acceptable to the user based on a response from the user.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of a model composer program, on a server computer within the distributed data processing environment of FIG. 1, for composing a machine learning model for complex data sources, in accordance with an embodiment of the present invention; and

FIG. 3 depicts a block diagram of components of the server computer executing the model composer program within the distributed data processing environment of FIG. 1, in accordance with an embodiment of the present invention.

### DETAILED DESCRIPTION

In the field of Automated Artificial Intelligence (AutoAI), creating a model from scratch may be difficult and time consuming when dealing with different types of data, for example, images, sensor data, traditional numerical data, etc. Often, AutoAI tools are applied in a small scope, where the domain of the data remains the same and the data types are identical. In the case of a complex domain, such as agriculture or natural resources, there may be a need to combine different data sources that work with specific models, and thereby utilize multimodal data. For example, for agricultural problems, data sources may include satellite images, crop types, crop yields, temperature, soil, precipitation, and location. Composing a single model that can use these various types of data is complex. Embodiments of the present invention recognize that efficiency may be gained by providing a system that can compose a new model architecture for a specific problem by combining two or more existing models that work with specific data types. Embodiments of the present invention also recognize that the system composes the new model based on the domain of the problem to be solved as well as the data and the task the user is trying to accomplish. Implementation of embodiments of the invention may take a variety of forms, and exemplary implementation details are discussed subsequently with reference to the Figures.

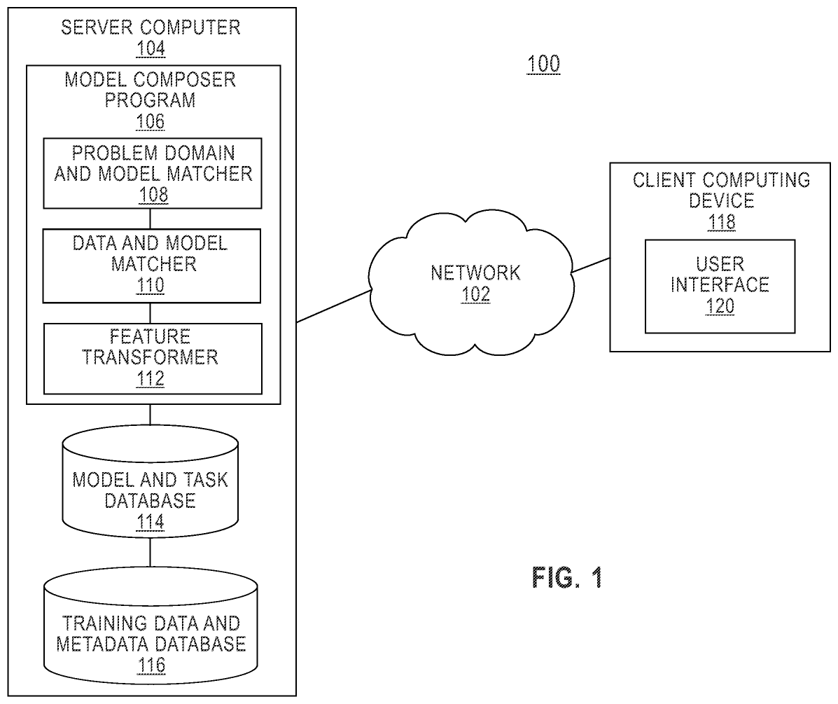

FIG. 1 is a functional block diagram illustrating a distributed data processing environment, generally designated 100, in accordance with one embodiment of the present invention. The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes server computer 104 and client computing device 118 interconnected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks capable of receiving and transmitting data, voice, and/or video signals, including multimedia signals that include voice, data, and video information. In general, network 102 can be any combination of connections and protocols that will support communications between server computer 104, client computing device 118, and other computing devices (not shown) within distributed data processing environment 100.

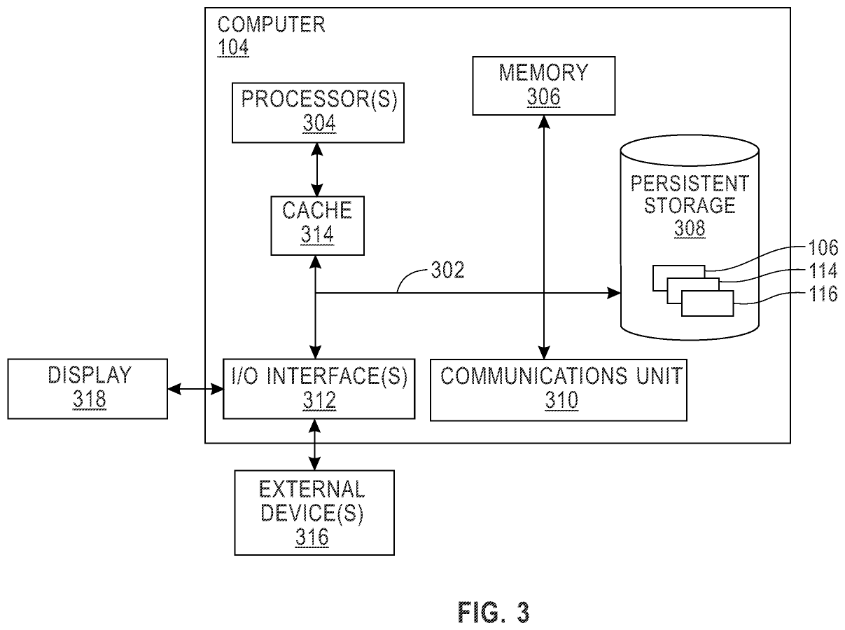

Server computer 104 can be a standalone computing device, a management server, a web server, a mobile computing device, or any other electronic device or computing system capable of receiving, sending, and processing data. In other embodiments, server computer 104 can represent a server computing system utilizing multiple computers as a server system, such as in a cloud computing environment. In another embodiment, server computer 104 can be a laptop computer, a tablet computer, a netbook computer, a personal computer (PC), a desktop computer, a personal digital assistant (PDA), a smart phone, an edge device, a containerized workload, or any programmable electronic device capable of communicating with client computing device 118 and other computing devices (not shown) within distributed data processing environment 100 via network 102. In another embodiment, server computer 104 represents a computing system utilizing clustered computers and components (e.g., database server computers, application server computers, etc.) that act as a single pool of seamless resources when accessed within distributed data processing environment 100. Server computer 104 includes model composer program 106, model and task database 114, and training data and metadata database 116. Server computer 104 may include internal and external hardware components, as depicted and described in further detail with respect to FIG. 3.

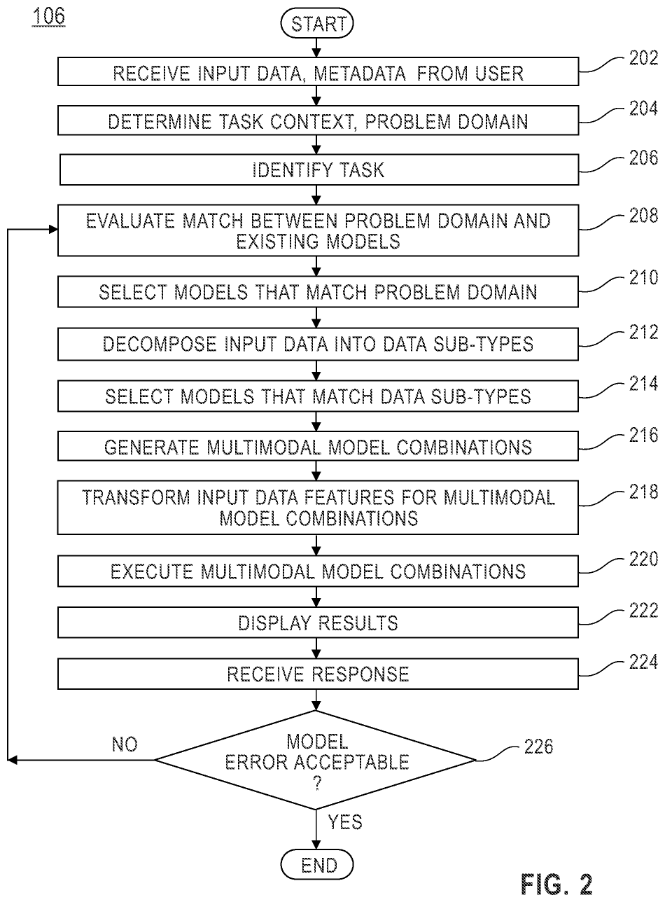

Model composer program 106 uses a database of machine learning models from one or more data domains to determine a combination of two or more models to be re-used in another domain by decomposing complex, multimodal data from a plurality of data sources. Model composer program 106 receives input data and associated metadata from a user. Model composer program 106 determines a task context and problem domain. Model composer program 106 identifies a requested task. Model composer program 106 evaluates a match between the problem domain and existing models. Model composer program 106 selects the models that match the problem domain. Model composer program 106 decomposes the input data into data sub-types. Model composer program 106 selects models that match the data sub-types. Model composer program 106 generates one or more multimodal model combinations. Model composer program 106 transforms the input data features for the multimodal model combinations. Model composer program 106 executes the multimodal model combinations. Model composer program 106 displays the results to the user and receives a response. If the response indicates the model error is unacceptable, then model composer program 106 iteratively repeats the process until the user is satisfied with the results. In the depicted embodiment, model composer program 106 includes problem domain and model matcher 108, data and model matcher 110, and feature transformer 112 as unique components. In another embodiment, the functions of problem domain and model matcher 108, data and model matcher 110, and feature transformer 112 are integrated into the function of model composer program 106. Model composer program 106 is depicted and described in further detail with respect to FIG. 2.

In an embodiment, problem domain and model matcher 108 is a component of model composer program 106 that obtains domain knowledge about the problem to be solved and compares the domain knowledge to existing models in model and task database 114 in order to find the best match between the problem domain and the existing models. As referred to herein, a problem domain is a field or scope of a machine learning activity and can be a broad description of an area of interest.

In an embodiment, data and model matcher 110 is a component of model composer program 106 that determines the context of a task requested by the user and compares the task to existing models in model and task database 114 in order to find the best match between the task and the existing models. As referred to herein, a task context is a specific area of interest within a problem domain within which the machine learning task is concerned.

In an embodiment, feature transformer 112 is a component of model composer program 106 that transforms the features of the input data elements to match the input data requirements of one or more existing models using a conversion model and/or algorithm.

Model and task database 114 and training data and metadata database 116 store information used by and generated by model composer program 106. In the depicted embodiment, model and task database 114 and training data and metadata database 116 reside on server computer 104. In another embodiment, model and task database 114 and training data and metadata database 116 may reside elsewhere within distributed data processing environment 100, provided that model composer program 106 has access to model and task database 114 and training data and metadata database 116, via network 102. A database is an organized collection of data. Model and task database 114 and training data and metadata database 116 can be implemented with any type of storage device capable of storing data and configuration files that can be accessed and utilized by model composer program 106, such as a database server, a hard disk drive, or a flash memory.

Model and task database 114 stores existing models that belong to a particular entity, such as a corporation, with corresponding tasks, as well multimodal model combinations composed by model composer program 106. Model and task database 114 also stores data input and responses from users, e.g., the user of client computing device 118, such as which multimodal model combinations yield acceptable results. Model and task database 114 may also store data associated with model use. For example, model and task database 114 may store the number of times model composer program 106 selects each existing model for composing a multimodal model combination.

Training data and metadata database 116 stores training data used to train the existing models stored in model and task database 114. For example, training data may include data used to create the machine learning system, i.e., model composer program 106. Training data can be considered as any data that is used to build a machine learning system, for example, model composer program 106, and set up its architecture and parameters. Training data can be divided into categories, such as training, validation, and test sets, and processed by a learning algorithm. Training data and metadata database 116 also stores metadata associated with the training data. For example, training data and metadata database 116 may store one or more ontology graphs used for data extraction, such as extraction of a problem domain. In another example, metadata may be any other data that can be used to create a machine learning system, such as the system description and types of data variables, but which is not processed by the learning algorithm.

The present invention may contain various accessible data sources, such as model and task database 114 and training data and metadata database 116, that may include personal data, content, or information the user wishes not to be processed. Personal data includes personally identifying information or sensitive personal information as well as user information, such as tracking or geolocation information. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal data. Model composer program 106 enables the authorized and secure processing of personal data. Model composer program 106 provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. Model composer program 106 provides information regarding personal data and the nature (e.g., type, scope, purpose, duration, etc.) of the processing. Model composer program 106 provides the user with copies of stored personal data. Model composer program 106 allows the correction or completion of incorrect or incomplete personal data. Model composer program 106 allows the immediate deletion of personal data.

Client computing device 118 can be one or more of a laptop computer, a tablet computer, a smart phone, a smart watch, a smart speaker, or any programmable electronic device capable of communicating with various components and devices within distributed data processing environment 100, via network 102. In an embodiment, client computing device 118 may be integrated into a vehicle of the user. For example, client computing device 118 may include a heads-up display in the windshield of the vehicle. Client computing device 118 may be a wearable computer. Wearable computers are miniature electronic devices that may be worn by the bearer under, with, or on top of clothing, as well as in or connected to glasses, hats, or other accessories. Wearable computers are especially useful for applications that require more complex computational support than merely hardware coded logics. In an embodiment, the wearable computer may be in the form of a smart watch. In one embodiment, the wearable computer may be in the form of a head mounted display. The head mounted display may take the form-factor of a pair of glasses, such as augmented reality (AR) glasses. In the embodiment where the head mounted display is a pair of AR glasses, the AR glasses can capture eye gaze information from a gaze point tracker, such as a camera associated with client computing device 118. In general, client computing device 118 represents one or more programmable electronic devices or combination of programmable electronic devices capable of executing machine readable program instructions and communicating with other computing devices (not shown) within distributed data processing environment 100 via a network, such as network 102. Client computing device 118 includes an instance of user interface 120.

User interface 120 provides an interface between model composer program 106 on server computer 104 and a user of client computing device 118. In one embodiment, user interface 120 is mobile application software. Mobile application software, or an “app,” is a computer program designed to run on smart phones, tablet computers and other mobile devices. In one embodiment, user interface 120 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. User interface 120 enables the user of client computing device 118 to input data, metadata, and task information, including task context for use by model composer program 106 and storage in model and task database 114 and/or training data and metadata database 116. User interface 120 also enables the user of client computing device 118 to receive the model results and accept the results or request further optimization of the model combination.

FIG. 2 is a flowchart depicting operational steps of model composer program 106, on server computer 104 within distributed data processing environment 100 of FIG. 1, for composing a machine learning model for complex data sources, in accordance with an embodiment of the present invention.

Model composer program 106 receives input data and associated metadata from a user (step 202). In an embodiment, the user of client computing device 118 submits a query, via user interface 120, to model composer program 106 for assistance with composing an optimum model for a machine learning task. For example, the user may input a request, such as “I want to predict the crop production for the 2022 season; the dataset I provided contains information related to field location and crop-growth-related activities.” In an embodiment, the received input data is multimodal, i.e., different types of data, such as text, images, sensor data, etc. In an embodiment, model composer program 106 receives one or more files from the user that contain the input data. In an embodiment, the input data may include target metrics and/or constraints, such as time or cost. In an embodiment, the user provides metadata associated with the input data. The metadata provides data attributes, such as which columns correspond to the labels and/or features in the file. For example, labels can represent the target value in a classification or regression, such as whether a sentence is positive, negative, or neutral. In another example, features are attributes of the data, such as, in a credit risk model, the features may include income, credit score, payments, location, etc. In an embodiment, the metadata includes a description of the data. Continuing the above example, “field location” and “crop-growth-related activities” may be considered as data descriptions. In an embodiment, if the input data files are large, then the user can point to the data source. For example, for satellite images, the user may point to a weather data archive. In an embodiment, model composer program 106 stores the metadata in an ontology in training data and metadata database 116.

Model composer program 106 determines a task context and a problem domain (step 204). In an embodiment, model composer program 106 processes the received input data and metadata to extract the context of the machine learning task. In an embodiment, model composer program 106 processes the data by using a chatbot to read textual information input by the user and applying one or more natural language processing (NLP) techniques to extract the information. In another embodiment, model composer program 106 queries the user directly, via user interface 120, for information associated with the task context and/or the problem domain. Continuing the previous example, model composer program 106 extracts a task context as crop production and a problem domain as agriculture. In an embodiment, data and model matcher 110 determines the context of the machine learning task requested by the user. In an embodiment, problem domain and model matcher 108 determines the domain of the problem to be solved.

Model composer program 106 identifies a requested task (step 206). In an embodiment, based on the received input and the determined task context and problem domain, model composer program 106 identifies the machine learning task for which the user requires a new model to perform. For example, the machine learning task may be a regression, a classification, clustering, etc. In another embodiment, the user provides the machine learning task, via user interface 120.

Model composer program 106 evaluates a match between the problem domain and existing models (step 208). In an embodiment, model composer program 106 compares the problem domain to the existing, pre-compiled models stored in model and task database 114 to determine which of the existing models are appropriate for use with the problem posed by the user. In an embodiment, model composer program 106 uses ontology matching to compare the problem domain to the existing models. In an embodiment, model composer program 106 uses problem domain and model matcher 108 to compare the domain knowledge to existing models in model and task database 114 in order to find the best match between the problem domain and the existing models. In an embodiment, model composer program 106 filters the models based on ontology attributes and/or other characteristics. For example, in agriculture, temperature and rainfall predictions will depend on the region/location under consideration, i.e., latitude and longitude. While the user includes the latitude and longitude information in the initial data input. model composer program 106 extracts other data, such as soil or weather data associated with the specified region, from model and task database 114. In an embodiment, model composer program 106 determines whether a threshold number of attributes of the existing model match the problem domain in order to consider the model a match. For example, if an ontology describing the problem domain includes six attributes, model composer program 106 may determine whether at least three of the six attributes are included in the existing model.

Model composer program 106 selects the models that match the problem domain (step 210). In an embodiment, based on the evaluation of each of the existing models with respect to the problem domain, model composer program 106 selects one or more matching models from the existing models in model and task database 114. In an embodiment, model composer program 106 uses problem domain and model matcher 108 to select the one or more matching models.

Model composer program 106 decomposes the input data into data sub-types (step 212). In an embodiment, model composer program 106 analyzes the multimodal input data to determine sub-types of the input data. For example, model composer program 106 determines whether the data is textual, numerical, sensor data, image data, etc. By determining the data sub-types, model composer program 106 can select from the existing, matching models that can process the data sub-types.

Model composer program 106 selects models that match the data sub-types (step 214). In an embodiment, based on the data sub-types of the input data, model composer program 106 selects one or more models that best match each of the data sub-types from the previously selected models that matched the problem domain, i.e., a subset of the previously selected models. In an embodiment, data and model matcher 110 compares the data sub-types to existing models in model and task database 114 in order to find the best match between the data sub-types and the existing models.

Model composer program 106 generates one or more multimodal model combinations (step 216). In an embodiment, model composer program 106 combines the selected two or more models to compose a machine learning model consisting of an optimal combination of models for the data sub-types. An optimal combination may be defined as the combination of models that result in the best accuracy, based on one or more chosen metrics for the machine learning task, such as precision, recall, F1 score, mean square for error (MSE), mean absolute error (MAE), root mean square error (RMSE), etc. In an embodiment, model composer program 106 generates a plurality of model combinations, where each combination may be optimal for a different metric. In an embodiment, each combination of models is a proposed, final machine learning model. In an embodiment, the number of combinations may be limited. For example, model composer program 106 may limit the number of combinations to five.

Model composer program 106 transforms the input data features for the multimodal model combinations (step 218). In an embodiment, model composer program 106 transforms the features of the input data to match the input requirements of the selected, pre-compiled models. In an embodiment, model composer program 106 uses a conversion model and/or algorithm to transform the features. In an embodiment, transforming the features includes extracting basic types of data from complex data types. For example, extracting text from the pixels of an image. In another example, transforming the features includes tasks such as fitting the data to smaller dimensionalities, i.e., reducing the number of attributes. In yet another example, transforming the features includes converting common spaces, such as transforming text to a vector of float numbers. In a further example, transforming the features includes using a mapping model, such as a neural network, to map input data, such as text in Portuguese, to data suitable for the selected model, such as text in English. In an embodiment, model composer program 106 uses feature transformer 112 to transform the features of the input data elements to match the input data requirements of the two or more selected models.

Model composer program 106 executes the multimodal model combinations (step 220). In an embodiment, model composer program 106 runs the one or more model combinations, i.e., proposed final models, with the transformed, multimodal data features in order to test the results as compared to the specified metrics. In an embodiment, the results include data associated with the machine learning task and/or the problem to be solved, as input by the user.

Model composer program 106 displays the results to the user (step 222). In an embodiment, model composer program 106 displays the results of executing the one or more multimodal model combinations to the user via user interface 120. In an embodiment where model composer program 106 executed a plurality of model combinations, model composer program 106 displays the results of each of the combinations. In an embodiment, the displayed results also include the identification of each of the models in the combination. In an embodiment, model composer program 106 displays the results graphically. In another embodiment, model composer program 106 displays the results textually, in a natural language. In an embodiment, model composer program 106 ranks the results for the plurality of model combinations based on a calculated error and displays the ranking. In an embodiment, in addition to the results, model composer program 106 displays a prompt to the user with which the user can express a level of satisfaction with the results. For example, model composer program 106 may display, via user interface 120, a message that asks, “Do the results meet the requirements for calculated model error?” in addition to an interactive button that reads “yes” and an interactive button that reads “no.” In an embodiment where model composer program 106 executed more than one combination of models, model composer program 106 provides a prompt for each combination. In the embodiment, model composer program 106 may also provide a prompt for the user to choose the preferred combination.

Model composer program 106 receives a response (step 224). In an embodiment, model composer program 106 receives a response from the user, via user interface 120.

Model composer program 106 determines whether the response indicates that the model error is acceptable (decision block 226). In an embodiment, model composer program 106 analyzes the received response to determine whether the user found the level of the calculated model error to be acceptable.

If model composer program 106 determines the response indicates that the model error is unacceptable (“no” branch, decision block 226), then model composer program 106 returns to step 208 and iteratively repeats the process until the user is satisfied with the results. In an embodiment, model composer program 106 may receive additional data from the user to change and/or improve the results. For example, the user may provide data with different attributes or sub-types to influence the selection of the existing models for the final, multimodal model.

If model composer program 106 determines the response indicates that the model error is acceptable (“yes” branch, decision block 226), then model composer program 106 ends execution. In an embodiment, model composer program 106 stores the acceptable final multimodal model in model and task database 114.

Continuing the example presented above, the user inputs the query “I want to predict the crop production for the 2022 season; the dataset I provided contains information related to field location and crop-growth-related activities.” Model composer program 106 receives the data input as well as metadata associated with the data input, as discussed with respect to step 202. The metadata includes the data type, a description of the dataset, and features, such as latitude and longitude. Model composer program 106 extracts a task context of crop production and a problem domain as agriculture, as discussed with respect to step 204. Model composer program 106 uses the input data to identify the machine learning task in order to be able to determine which of the existing models in model and task database 114 relate to the task. Model composer program 106 also retrieves an ontology tree with concepts associated with the problem to be solved and, using one or more NLP techniques, matches the input data to one or more branches of the ontology tree. For example, model composer program 106 retrieves a “crop production” ontology from a public source. The ontology has branches for crop regulations and for crop growth activity, the latter having a connection to the user-provided dataset. Further, the crop growth activity branch has a branch for location environmental factors. From location environmental factors extend branches for latitude/longitude, soil, humidity, and temperature. The latitude/longitude branch has a connection with the user-provided dataset. Model composer program 106 evaluates the existing models in model and task database 114, as discussed with respect to steps 208, finding multiple models that include latitude/longitude data in addition to other data. Model composer program 106 determines that of the existing models that include the latitude/longitude data, the models for soil, temperature, and temperature/humidity match the problem domain, as discussed with respect to step 210. Model composer program 106 generates a multimodal model with the combination of the soil, temperature and temperature/humidity models, as discussed with respect to step 216. Model composer program 106 executes the multimodal model with the user-provided data and displays the results, i.e., a prediction of crop growth for 2022 in the specified location, to the user, as discussed with respect to steps 220 and 222. The user responds that the model error associated with the multimodal model prediction is acceptable, and model composer program 106 receives the response, as discussed with respect to step 224.

FIG. 3 depicts a block diagram of components of server computer 104 within distributed data processing environment 100 of FIG. 1, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

Server computer 104 can include processor(s) 304, cache 314, memory 306, persistent storage 308, communications unit 310, input/output (I/O) interface(s) 312 and communications fabric 302. Communications fabric 302 provides communications between cache 314, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer readable storage media. In this embodiment, memory 306 includes random access memory (RAM). In general, memory 306 can include any suitable volatile or non-volatile computer readable storage media. Cache 314 is a fast memory that enhances the performance of processor(s) 304 by holding recently accessed data, and data near recently accessed data, from memory 306.

Program instructions and data used to practice embodiments of the present invention, e.g., model composer program 106, model and task database 114, and training data and metadata database 116, are stored in persistent storage 308 for execution and/or access by one or more of the respective processor(s) 304 of server computer 104 via cache 314. In this embodiment, persistent storage 308 includes a magnetic hard disk drive. Alternatively, or in addition to a magnetic hard disk drive, persistent storage 308 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices, including resources of client computing device 118. In these examples, communications unit 310 includes one or more network interface cards. Communications unit 310 may provide communications through the use of either or both physical and wireless communications links. Model composer program 106, model and task database 114, training data and metadata database 116, and other programs and data used for implementation of the present invention, may be downloaded to persistent storage 308 of server computer 104 through communications unit 310.

I/O interface(s) 312 allows for input and output of data with other devices that may be connected to server computer 104. For example, I/O interface(s) 312 may provide a connection to external device(s) 316 such as a keyboard, a keypad, a touch screen, a microphone, a digital camera, and/or some other suitable input device. External device(s) 316 can also include portable computer readable storage media such as, for example, thumb drives, portable optical or magnetic disks, and memory cards. Software and data used to practice embodiments of the present invention, e.g., model composer program 106, model and task database 114, and training data and metadata database 116 on server computer 104, can be stored on such portable computer readable storage media and can be loaded onto persistent storage 308 via I/O interface(s) 312. I/O interface(s) 312 also connect to a display 318.

Display 318 provides a mechanism to display data to a user and may be, for example, a computer monitor. Display 318 can also function as a touch screen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The foregoing descriptions of the various embodiments of the present invention have been presented for purposes of illustration and example, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
receiving, by one or more computer processors, data and associated metadata corresponding to a machine learning task from a user;
determining, by one or more computer processors, a task context and a problem domain based on the received data and the associated metadata;
based on the task context and the problem domain, identifying, by one or more computer processors, the machine learning task;
evaluating, by one or more computer processors, a match between the problem domain and one or more pre-compiled models;
based on the match, selecting, by one or more computer processors, at least two of the one or more pre-compiled models;
generating, by one or more computer processors, one or more multimodal model combinations with the selected at least two of the one or more pre-compiled models;
executing, by one or more computer processors, the one or more multimodal model combinations with the received data and the associated metadata;
displaying, by one or more computer processors, results of the executed one or more multimodal model combinations to the user; and
determining, by one or more computer processors, whether a level of error associated with the results is acceptable to the user based on a response from the user.

2. The computer-implemented method of claim 1, further comprising:
responsive to determining the level of error associated with the results is not acceptable to the user, iteratively repeating, by one or more computer processors, a process of generating and executing the one or more multimodal models until the level of error associated with the results is acceptable to the user.

3. The computer-implemented method of claim 2, further comprising:
receiving, by one or more computer processors, additional data from the user to improve the results.

4. The computer-implemented method of claim 1, further comprising:
decomposing, by one or more computer processors, the received data into two or more data sub-types; and
based on the data sub-types, selecting, by one or more computer processors, a subset of the selected at least two of the one or more pre-compiled models.

5. The computer-implemented method of claim 1, wherein the received data is multimodal data.

6. The computer-implemented method of claim 1, wherein determining the task context and the problem domain comprises:
processing, by one or more computer processors, the received data and the associated metadata using a chatbot to read textual information; and
applying, by one or more computer processors, one or more natural language processing techniques to the received data and the associated metadata to extract information corresponding to the task context and the problem domain.

7. The computer-implemented method of claim 1, wherein the machine learning task includes at least one of a regression, a classification, and a clustering.

8. A computer program product comprising:
one or more computer readable storage media and program instructions collectively stored on the one or more computer readable storage media, the stored program instructions comprising:
program instructions to receive data and associated metadata corresponding to a machine learning task from a user;
program instructions to determine a task context and a problem domain based on the received data and the associated metadata;
based on the task context and the problem domain, program instructions to identify the machine learning task;
program instructions to evaluate a match between the problem domain and one or more pre-compiled models;
based on the match, program instructions to select at least two of the one or more pre-compiled models;
program instructions to generate one or more multimodal model combinations with the selected at least two of the one or more pre-compiled models;
program instructions to execute the one or more multimodal model combinations with the received data and the associated metadata;
program instructions to display results of the executed one or more multimodal model combinations to the user; and
program instructions to determine whether a level of error associated with the results is acceptable to the user based on a response from the user.

9. The computer program product of claim 8, the stored program instructions further comprising:
responsive to determining the level of error associated with the results is not acceptable to the user, program instructions to iteratively repeat a process of generating and executing the one or more multimodal models until the level of error associated with the results is acceptable to the user.

10. The computer program product of claim 9, the stored program instructions further comprising:
program instructions to receive additional data from the user to improve the results.

11. The computer program product of claim 8, the stored program instructions further comprising:
program instructions to decompose the received data into two or more data sub-types; and
based on the data sub-types, program instructions to select a subset of the selected at least two of the one or more pre-compiled models.

12. The computer program product of claim 8, wherein the received data is multimodal data.

13. The computer program product of claim 8, wherein the stored program instructions to determine the task context and the problem domain comprise:
program instructions to process the received data and the associated metadata using a chatbot to read textual information; and
program instructions to apply one or more natural language processing techniques to the received data and the associated metadata to extract information corresponding to the task context and the problem domain.

14. The computer program product of claim 8, wherein the machine learning task includes at least one of a regression, a classification, and a clustering.

15. A computer system comprising:
one or more computer processors;
one or more computer readable storage media;
program instructions collectively stored on the one or more computer readable storage media for execution by at least one of the one or more computer processors, the stored program instructions comprising:
program instructions to receive data and associated metadata corresponding to a machine learning task from a user;
program instructions to determine a task context and a problem domain based on the received data and the associated metadata;
based on the task context and the problem domain, program instructions to identify the machine learning task;
program instructions to evaluate a match between the problem domain and one or more pre-compiled models;
based on the match, program instructions to select at least two of the one or more pre-compiled models;
program instructions to generate one or more multimodal model combinations with the selected at least two of the one or more pre-compiled models;
program instructions to execute the one or more multimodal model combinations with the received data and the associated metadata;
program instructions to display results of the executed one or more multimodal model combinations to the user; and
program instructions to determine whether a level of error associated with the results is acceptable to the user based on a response from the user.

16. The computer system of claim 15, the stored program instructions further comprising:
responsive to determining the level of error associated with the results is not acceptable to the user, program instructions to iteratively repeat a process of generating and executing the one or more multimodal models until the level of error associated with the results is acceptable to the user.

17. The computer system of claim 16, the stored program instructions further comprising:
program instructions to receive additional data from the user to improve the results.

18. The computer system of claim 15, the stored program instructions further comprising:
program instructions to decompose the received data into two or more data sub-types; and
based on the data sub-types, program instructions to select a subset of the selected at least two of the one or more pre-compiled models.

19. The computer system of claim 15, wherein the received data is multimodal data.

20. The computer system of claim 15, wherein the stored program instructions to determine the task context and the problem domain comprise:
program instructions to process the received data and the associated metadata using a chatbot to read textual information; and
program instructions to apply one or more natural language processing techniques to the received data and the associated metadata to extract information corresponding to the task context and the problem domain.
